(19) United States
(12) Patent Application Publication
(10) Pub. No.: US 2007/0163565 A1
(43) Pub. Date: Jul. 19, 2007

(54) Multi-speed concrete saw

(76) Inventor: Donald F. Meister, Overland Park, KS (US)

Correspondence Address: HENRICKS SLAVIN AND HOLMES LLP;SUITE 200, 840 APOLLO STREET, EL SEGUNDO, CA, 90245, US

(21) Appl. No.: 11/331,725

(22) Filed: Jan. 16, 2006

(51) Int. Cl. B28D 1/04

(52) U.S. Cl. 125/13.01

(57) ABSTRACT

A concrete saw can be operated at multiple speeds. The saw includes at least one neutral. A multispeed gearbox has one configuration with no more than two gear shafts. The gearbox can be mounted directly to an engine output shaft. The engine output shaft can be perpendicular to the blade drive shaft, and the blade drive shaft can be driven by belts from the gearbox.

### BACKGROUND

1. Field

These inventions relate to concrete saws.

2. Related Art

In the concrete industry, large slabs of concrete are used to form road to beds, building floors and other structures used for its strength and durability. Seams, grooves or other cuts in the concrete may be made in the slabs to form expansion joints, control stress cracks as the slabs cure or to form channels or openings in the slabs to accept other structures. Concrete saws are used to cut the seams, grooves or other openings, and such concrete saws are often very heavy and difficult to move along the concrete slab. For large or heavy construction applications, heavy self-propelled saws or other large concrete saws are used. Examples of concrete saws and their construction and operation can be found in a number of patents, including U.S. Pat. No. 5,809,985, entitled “Self-Propelled Saw,” U.S. Pat. No. 5,743,247, entitled “Method and Apparatus for Safe Operation of Self-Propelled Concrete Saw,” U.S. Pat. No. 5,680,854, entitled “Self-Propelled Saw,” U.S. Pat. No. 5,477,844, entitled “Slurry Recovery System for a Wet Cutting Saw,” and U.S. Pat. No. 4,664,645 entitled “Blade Drive Shaft Assembly,” all of which are incorporated herein by reference. During setup and operation of the saw, an operator walks behind the saw to control the direction, cutting speed, cutting depth and other operating conditions under which the saw operates. The saw includes one or more wheels allowing the saw to move along the concrete and a frame supported by the wheels on which is mounted a motor or other power supply for operating a saw blade and often for driving one or more wheels to move the saw along the concrete surface. One or more handles extend behind the saw about the level of an operator's hands to allow the operator to manually position the saw. Typically, the saw blade is in the front of the saw and handles extend behind the saw.

For a typical straight cut, the operator aligns the saw blade and often a cutting guide with the intended cutting path. The saw is maneuvered with the saw blade raised above the concrete until the blade and cutting guide are aligned with the cutting path. As the saw blade engages the concrete or other surface to be cut, the blade cuts into the concrete to the desired depth, such as the depth selected by the operator. At the desired depth, the drive wheels are engaged to propel the saw forward to cut the desired slot or groove, which typically follows a straight cut path.

For some saws, such as the self-propelled saws, a number of different sizes of blades can be used on the saw. However, because different sizes of blades have optimum operating conditions, such as optimum blade speeds, it is desirable to operate one blade under one operating configuration, such as at one speed, and a different sized blade under another operating configuration, such as at another speed. Different operating configurations can be carried out by running the saw motor at different speeds, changing the motor output and blade input pulleys to produce different ratios, or in other ways. Saws having gearboxes that can operate at multiple speeds can make easier to change the operating configuration when changing from one blade size to another.

### SUMMARY

A concrete saw that can operate at multiple speeds may have a gearbox for operating the saw at more than one speed. The gearbox can be configured to have a relatively small volume. The gearbox can also be configured to make changing from one speed to another than saws without multiple speed gearboxes. The gearbox may also be configured in a self-propelled saw to allow the saw to be moved from one location to another without engaging the saw blade drive shaft. Additionally, the gearbox may be configured so as to be relatively insulated from loading and stresses experienced by a saw blade during cutting.

In one example of a concrete saw, a motor is provided for driving a blade support element. A drive element, for example a gear, is configured to be driven by the motor and provides driving input to drive the blade support element. The drive element is also configured so that it is part of a mechanism by which the mechanism has a neutral position. In the neutral position, the drive element does not drive the blade support element. In one configuration, the drive element changes to a neutral configuration by disengaging from an output element and in another configuration an input element disengages from the drive element. In another configuration, the drive element, for example in the form of a gear, can move from an engagement position about a splined shaft to a disengaged position about the shaft, for example past a point on the shaft where the splines terminate. A neutral position allows the motor to be on, or the saw moved with the motor on, but without the blade turning. The blade is disengaged from the motor.

In another example a concrete saw, a motor is provided for driving a blade support element. A drive element, for example a plurality of gears between the motor and the blade support element drive the blade at at least two different speeds. In one example, the gears are configured to include a neutral position. In one configuration, the saw can operate at three speeds. In another configuration, flexible drive elements such as belts can be used to couple or transfer drive from the gears to the blade support element. The gears can be arranged on as few as two shafts, permitting a relatively small gearbox. The gearbox can be driven directly from the motor, for example through bevel gears, and the motor can be arranged perpendicular to the blade support element, such as a blade drive shaft.

In another example, a concrete saw having a motor for driving a cutting blade includes a gearbox for driving the blade at at least two different speeds where the gearbox has no more than two shafts supporting the gears. The gearbox can be configured to operate at three different speeds, and can include at least one and preferably two neutral positions. In a saw with three speeds, the gears sets can be arranged efficiently by having the shift sequence out of numerical order, for example from high, to low, to medium.

In a further example of a concrete saw, the motor drives a saw blade output drive shaft through a gearbox having an output for driving a drive belt between the gearbox and the blade drive shaft. The gearbox can be driven by a gear coupled to a motor output shaft for engaging and driving a gear in the gearbox. The motor output shaft can be inline with the direction of saw travel. In one configuration, the gearbox can operate at at least two speeds, or three speeds. The gearbox may also have one or two neutral positions.

These and other examples are set forth more fully below in conjunction with drawings, a brief description of which follows.

### BRIEF DESCRIPTION OF THE DRAWINGS

FIG. 1 is an upper right isometric view of a concrete saw for use with the present inventions.

FIG. 2 is a right side elevation view of a part of the saw of FIG. 1.

FIG. 3 is a left side elevation view of the saw of FIG. 1.

FIG. 4 is a side elevation of a gearbox assembly for use with the saw of FIG. 1.

FIG. 5 is a front elevation view of a gear assembly for use with the saw of FIG. 1 in a high-speed configuration.

FIG. 5A is a schematic representation of a gear shift pattern and a gear shift in a position for a high-speed configuration.

FIG. 6 is a front elevation view of a gear assembly for use with the saw of FIG. 1 in a neutral configuration.

FIG. 6A is a schematic representation of a gear shift pattern and a gear shift in a position for a neutral configuration.

FIG. 7 is a front elevation view of a gear assembly for use with the saw of FIG. 1 in a low speed configuration.

FIG. 7A is a schematic representation of a gear shift pattern and a gear shift in a position for the low speed configuration.

FIG. 8 is a front elevation view of a gear assembly for use with the saw of FIG. 1 in a neutral configuration.

FIG. 8A is a schematic representation of a gear shift pattern and a gear shift in a position for the neutral configuration.

FIG. 9 is a front elevation view of a gear assembly for use with the saw of FIG. 1 in a medium speed configuration.

FIG. 9A is a schematic representation of a gear shift pattern and a gear shift in a position for a medium speed configuration.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

An example of a saw and of a method of making and using the saw are described. Depending on what feature or features are incorporated in a given structure or a given method, benefits can be achieved in the structure or the method. For example, saws using belt drives between a multi-speed gear box and a blade drive shaft may result in the gearbox having a longer lifetime. Additionally, some saw configurations may also benefit from the use of smaller components.

These and other benefits will become more apparent with consideration of the description of the examples herein. However, it should be understood that not all of the benefits or features discussed with respect to a particular example must be incorporated into a saw, component or method in order to achieve one or more benefits contemplated by these examples. Additionally, it should be understood that features of the examples can be incorporated into a saw, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

An example of a saw configuration and a method of making and using the saw are described herein, and some features have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

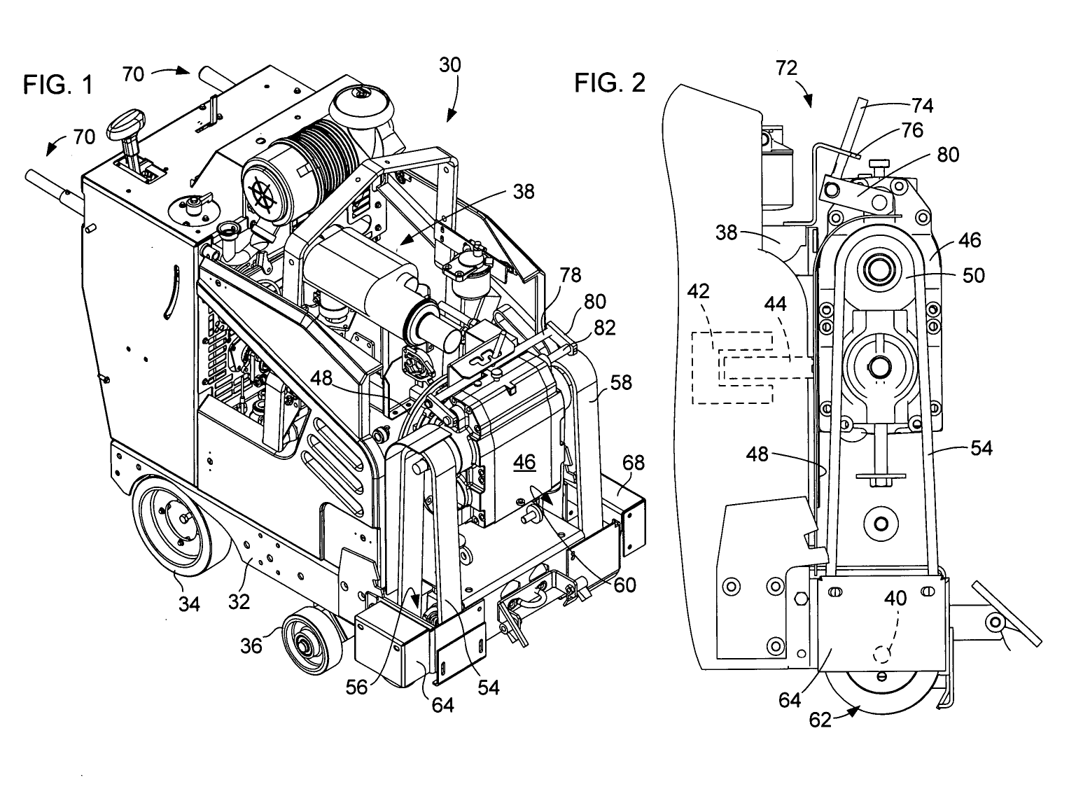

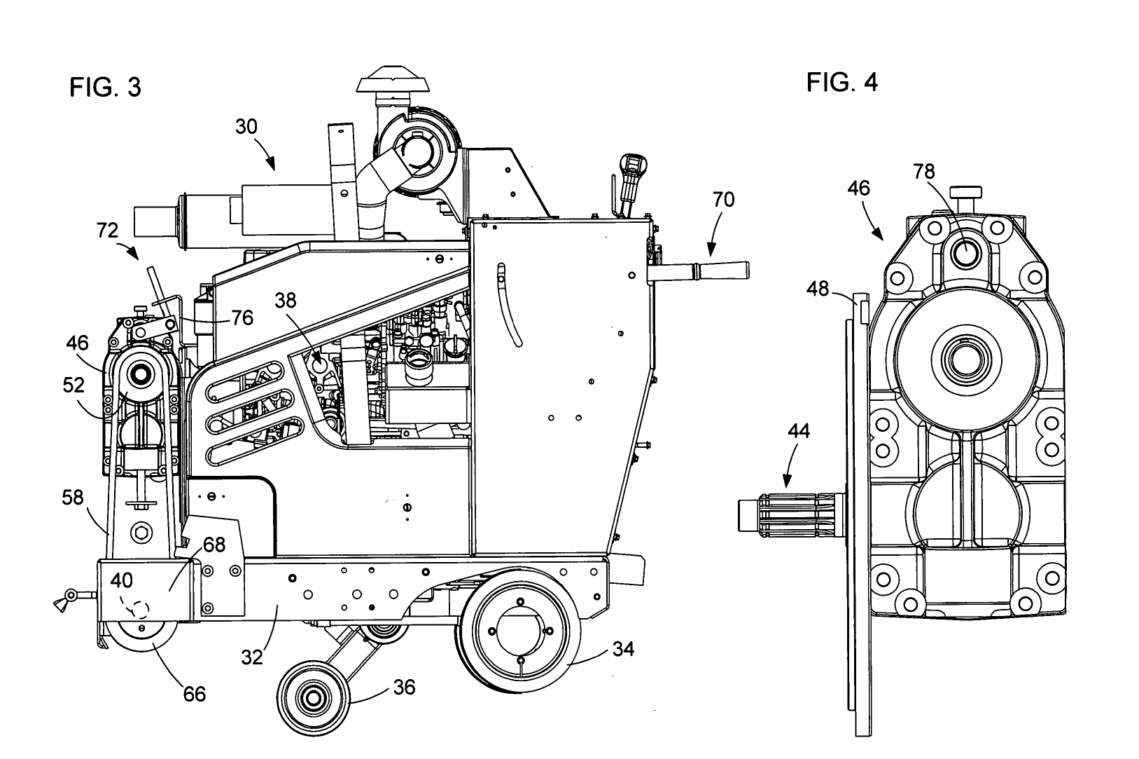

In one example of a saw (FIGS. 1-3), a concrete saw 30 includes a frame 32 supported by wheels 34 and 36. The wheels 34 and 36 allow the saw to move across a concrete surface for cutting. Details about exemplary constructions and configurations of a concrete saw, for example self-propelled saws, are provided in the above-identified patents. A motor such as an internal combustion engine 38 is supported on the frame 32 through vibration isolation components such as those described in the above-identified patents. The engine 38 may be used to drive a blade drive shaft 40 (FIGS. 2 and 3), which supports and drives a saw blade (not shown). The engine 38 may also be used to operate, through a transmission, the drive wheels 34 to propel the concrete saw. The engine 38 includes an engine output shaft 42 with an internally splined output element for engaging and driving an input shaft 44 to a drive element in the form of a gearbox 46 in this example through a cover plate 48. The gearbox 46 includes at least one, and in the example shown in the drawings, two gearbox output pulleys, a right output pulley 50 (FIG. 2) and a left output pulley 52 (FIG. 3). The right output pulley 50 drives a right belt 54, a single or multiple set of belts, around a right drive shaft pulley 56. The left output pulley 52 drives a left belt 58 (FIG. 3), also a single or multiple set of belts, around a left drive shaft pulley 60. The right and left drive shaft pulleys are directly connected to the blade drive shaft 40. A blade (not shown) can be mounted on the right side of the saw through right blade flanges 62 after removing a right blade flange cover 64 (FIG. 2). A blade (not shown) can be mounted on the left side of the saw through left blade flanges 66 after removing a left blade flange cover 68 (FIG. 3). Other blade shaft and blade shaft input configurations can also be used. For example, the blade shaft can be driven through a single drive belt or single set of drive belts. The blade drive shaft can also be driven by a rigid linkage between the gearbox output and the blade drive shaft as opposed to flexible belts.

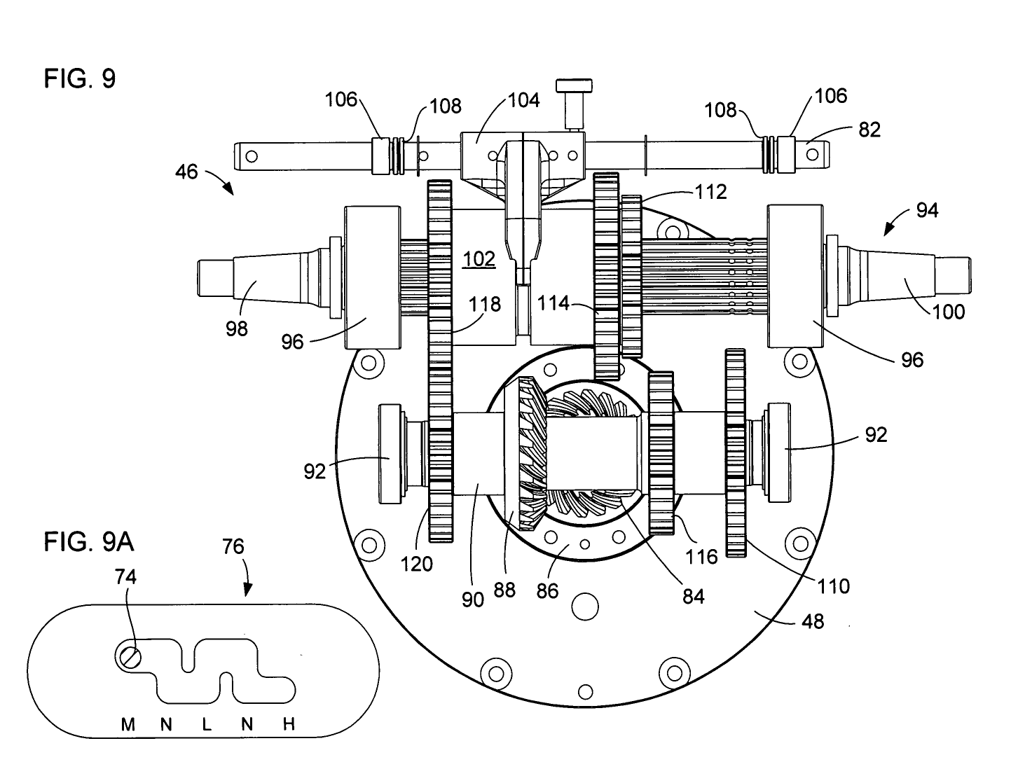

In the example shown in the drawings, the gearbox 46 is rigidly mounted to and supported on the engine by the cover plate 48. The cover plate 48 is bolted to a front of the engine, and the input shaft 44 to the gearbox engages the splined output element 42 in the engine. The splined output element may be a drive assembly which may, but need not, include a clutch or other means for disengaging the motor from the gearbox. One example of a suitable clutch arrangement is shown in FIG. 9 of U.S. Pat. No. 5,810,448. In other configurations for the gearbox, the gearbox can be separate from the cover plate and/or coupled to the engine output through other means. In the present example, the engine 38 is aligned and has its output shaft with the output element 42 aligned with the direction of travel of the saw. Therefore, the output shaft and output element 42 are directed parallel to the direction of travel, and perpendicular to the transverse orientation of the blade drive shaft 40. This engine orientation allows a larger engine to be placed on the saw within the same overall saw envelope compared to a saw having an engine oriented transverse to the direction of travel. Additionally, this orientation permits direct coupling of the gearbox 46 to the engine output at the front of the saw, so that the added volume occupied by the gearbox does not increase the width of the saw.

The gearbox 46 is mounted directly to the engine block, which in turn is supported on the frame through isolator elements (not shown). As a result, engine vibration and gearbox vibration that may occur during operation can be isolated or insulated from the frame, and therefore from the handles 70 at the rear of the saw (FIGS. 1 and 3). Additionally, mounting the gearbox directly to the engine allows the gearbox output to be applied to the blade drive shaft through belts or other flexible means, which helps to insulate the gearbox and other operating components from the loads and impacts experienced by the blade during cutting.

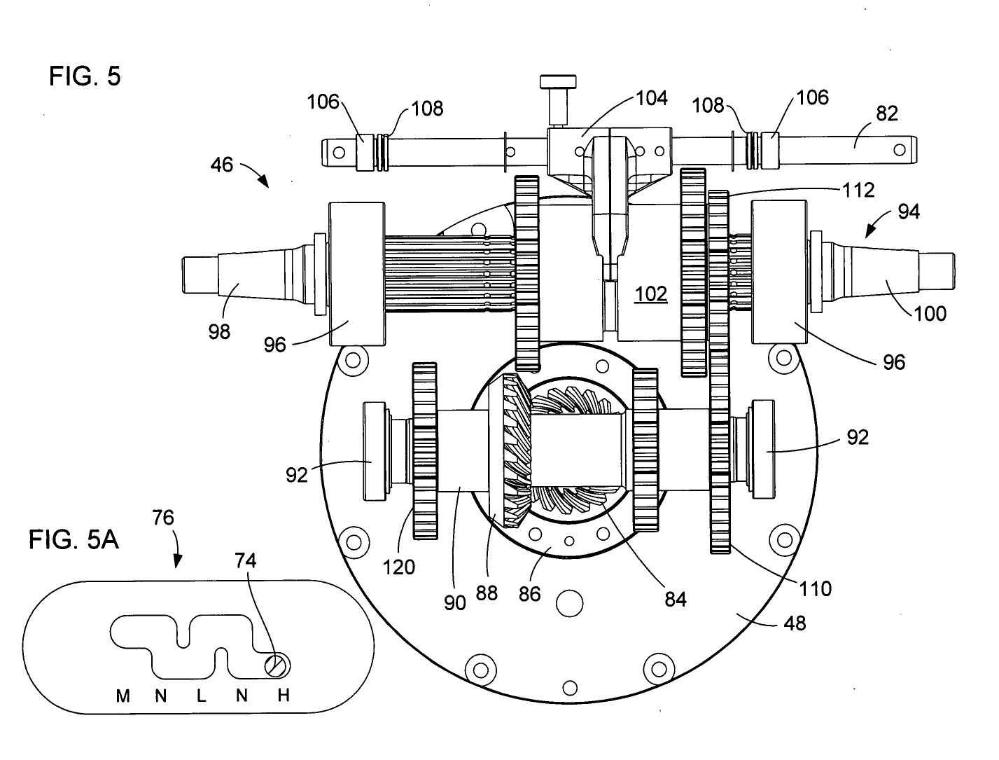

The gearbox in the example shown in the drawings includes a plurality of gear sets on a plurality of gear shafts (described more fully below) that can be used for driving the saw blade at different speeds for a given input rpm from the engine. The saw includes a speed selector 72 on the gearbox 46. In the example shown in drawings, the speed selector includes a handle 74 captured in a shift pattern 76, which is mounted to the engine. The shift pattern guides the operator in selecting the appropriate position for the handle 74 for the desired speed setting or neutral position. The shift pattern may also include appropriate indicators for the speed and neutral positions, such as “M” for medium speed, “N” for neutral, “L” for low, and “H” for high (as shown in FIGS. 5A-9A) . Shift patterns other than that shown in FIG. 1 can also be used for the given gear arrangement described below. Additionally, other gear arrangements may dictate other shift pattern configurations.

The handle 74 is pivotally coupled to a transverse shift bar 78, which in turn is coupled through connector bars 80 to a gear selector shaft 82 extending through appropriate seals and bearings into the gearbox. The transverse shift bar 78 and the connector bars 80 transfer the handle movement to the gear selector shaft 82.

Considering the present example of the gearbox in more detail with respect to FIGS. 5-9, the gearbox includes a bevel drive gear 84 on or coupled to the input shaft 44 (FIG. 2). The bevel drive gear is supported by an appropriate bearing assembly (not shown) supported by a mounting plate 86. The bevel drive gear 84 engages and drives a bevel driven or follower gear 88 mounted on a lay shaft or drive shaft 90, to change the engine output by 90 degrees, to be parallel to the blade drive shaft. The drive shaft 90 is supported on radial bearing assemblies 92 in the gearbox housing. The drive shaft 90 turns a at least one gear, such as the gear 110, and in the example shown in the drawings the drive shaft 90 turns a plurality of gears, each of which are configured to engage a corresponding driven or output gear to produce the desired rpm on an output shaft.

Specifically, the gearbox 46 includes an externally splined output shaft 94 supported by a pair of radial bearings 96 in the gearbox housing. The splined shaft includes output shaft ends 98 and 100 for engaging and supporting the output shaft pulleys 50 and 52, respectively, shown in FIGS. 2 and 3. The pulleys drive the respective belts for driving the blade drive shaft. The pulleys may be keyed or otherwise engaged with the shaft ends. The shaft may also be sealed with appropriate seals where the shaft ends emerge from the gearbox housing.

The output shaft 94 also includes at least one driven or output gear for engaging the drive gear, and at least one or the other of the drive gear and the output gear have a configuration by which the gears disengage or otherwise have a neutral configuration, thereby disengaging the blade drive shaft from the motor. In the neutral position, the gear does not drive the blade support element. In one possible configuration, the drive gear changes to a neutral configuration by disengaging from the output gear, and in another configuration the output gear changes to a neutral configuration by disengaging from the input element. Other configurations are possible as well, including one where the gear can move from an engagement position about a splined shaft to a disengaged position about the shaft, for example past a point on the shaft where the splines terminate. The neutral position allows the motor to be on, or the saw moved with the motor on, but without the blade turning. The blade is disengaged from the motor.

In the example shown in the drawings, the output shaft 94 includes driven or output gears corresponding to the driving gears on the drive shaft 90, as described more fully below. The driven gears engage the splined shaft 94 and are axially fixed to a collar 102 and fixed relative to one another, so that movement of the collar 102 also moves axially the gears on the splined shaft 94 in unison. The collar 102 rotatably engages a gear selector fork 104 in such a way that the collar moves axially along the splined shaft when the gear selector fork moves axially. The collar 102 rotates with the splined shaft within a selector fork, which remains substantially rotationally fixed while the splined shaft rotates. The gears on the drive shaft and the output shaft are sized and arranged on their respective shafts in such a way that they have engaged positions and neutral positions.

The gear selector fork 104 is fixed to and supported on the gear selector shaft 82, and moves axially with the gear selector shaft. The gear selector shaft includes appropriate bearings 106 and seals 108 to reliably support the selector shaft in the gearbox housing. The handle 74 (FIGS. 1-3) moves the gear selector shaft, which in turn moves the output gear and collar assembly along the splined shaft 94 to select the appropriate speed setting or the neutral position.

As shown in FIG. 5, the drive shaft 90 includes a high-speed drive gear 110 rotationally fixed on but axially movable over the drive shaft for rotation with the shaft. When the gear selector shaft 82 is in the position shown in FIG. 5, according to the handle location represented in FIG. 5A, the high-speed drive gear 110 engages and drives a high-speed driven or output gear 112, and the other speed gears are disengaged. In the high-speed position, running the engine with the high-speed gears engaged turns the blade drive shaft at the highest rpm for the given configuration, for example where the engine operates at the highest reasonably rpm, which for some saws may be about 3000 rpm.

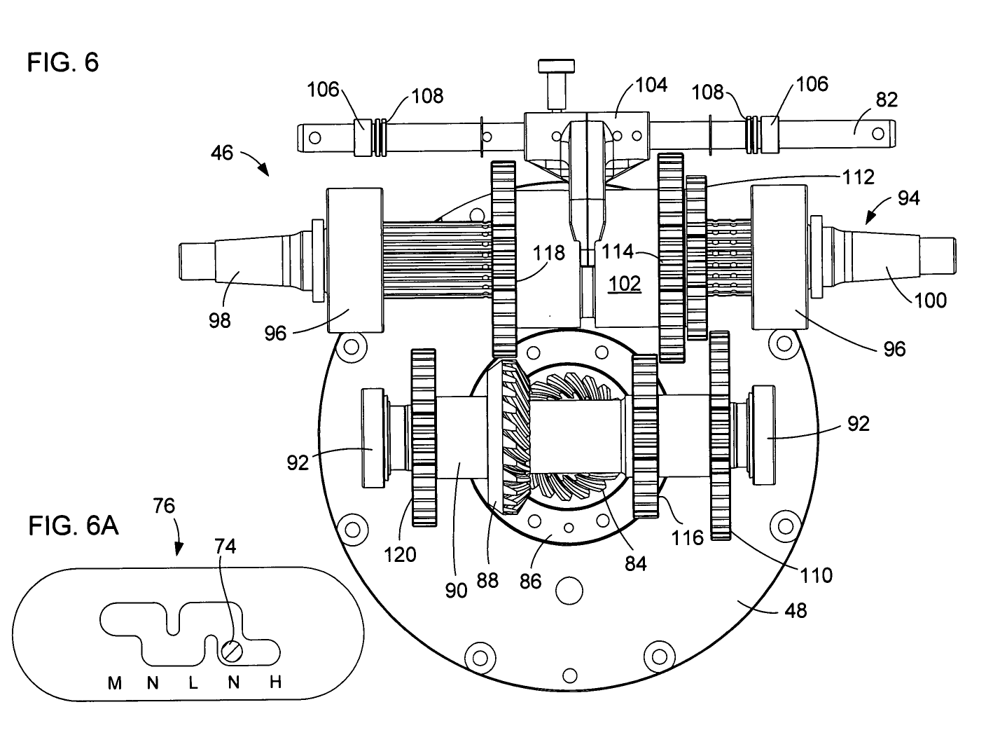

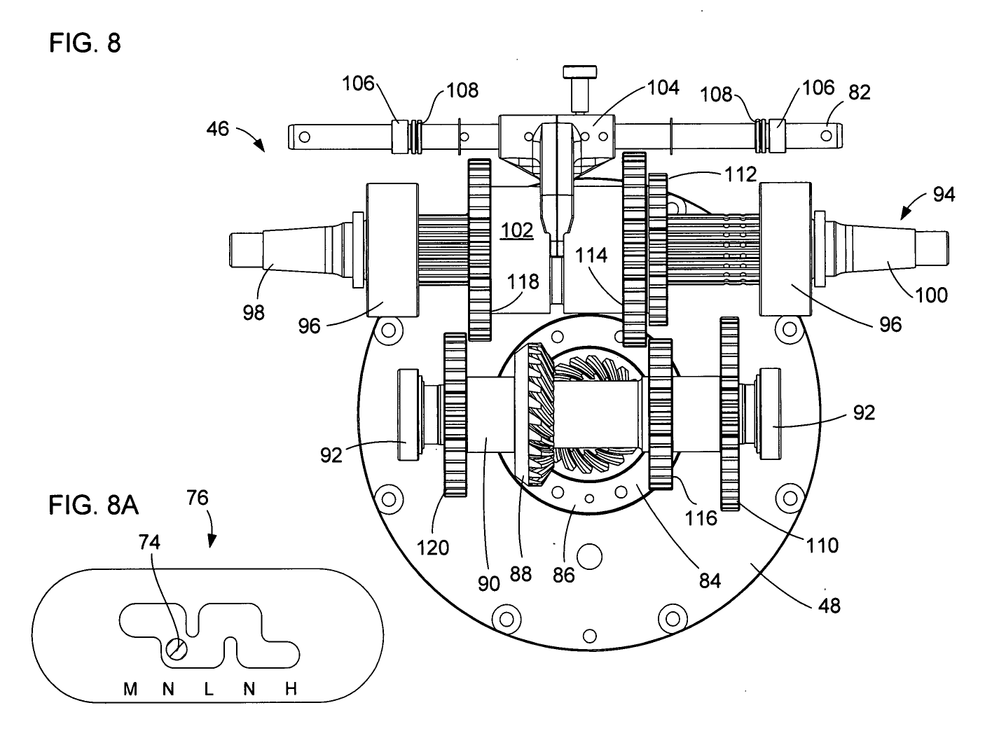

As shown in FIG. 6, the drive shaft 90 includes a neutral position where none of the drive gears on the drive shaft 90 engage any of the output gears on the splined shaft 94. When the gear selector shaft 82 is in the position shown in FIG. 6, according to the handle location represented in FIG. 6A, none of the drive gears engage any of the output gears. The axial positions of the drive gears relative to each other and the axial positions of the output gears relative to each other are such as to provide complete disengagement between the drive and driven gears. This neutral configuration, as well as the other neutral configuration discussed below with respect to FIGS. 8-8A, allows the operator to use the self-propelled mechanism on the saw driven by the motor to move the saw without having the blade turning. The neutral configuration also allows easier shifting from one gear to another, or one speed to another as the gear arrangements permit easier alignment of the gear pairs when shifting out of one speed and shifting into another speed. Shifting will typically occur with the engine off, for example for blade changes, when the engine is turned off to remove one size blade to be replaced by another size blade. The different sized blades may require different blade speeds, and therefore different gear settings in the gearbox. In the configuration shown in FIG. 6, the gear arrangement has the high-speed output gear 112 and the low speed output gear 114 positioned axially in the space between (the position after the high-speed output gear disengages from the high-speed drive gear and before the low speed output gear 114 engages the low speed drive gear 116) the high-speed drive gear 110 and the low speed drive gear 116. Additionally, the medium speed output gear 118 is next to the bevel follower gear 88 and spaced from the medium drive gear 120.

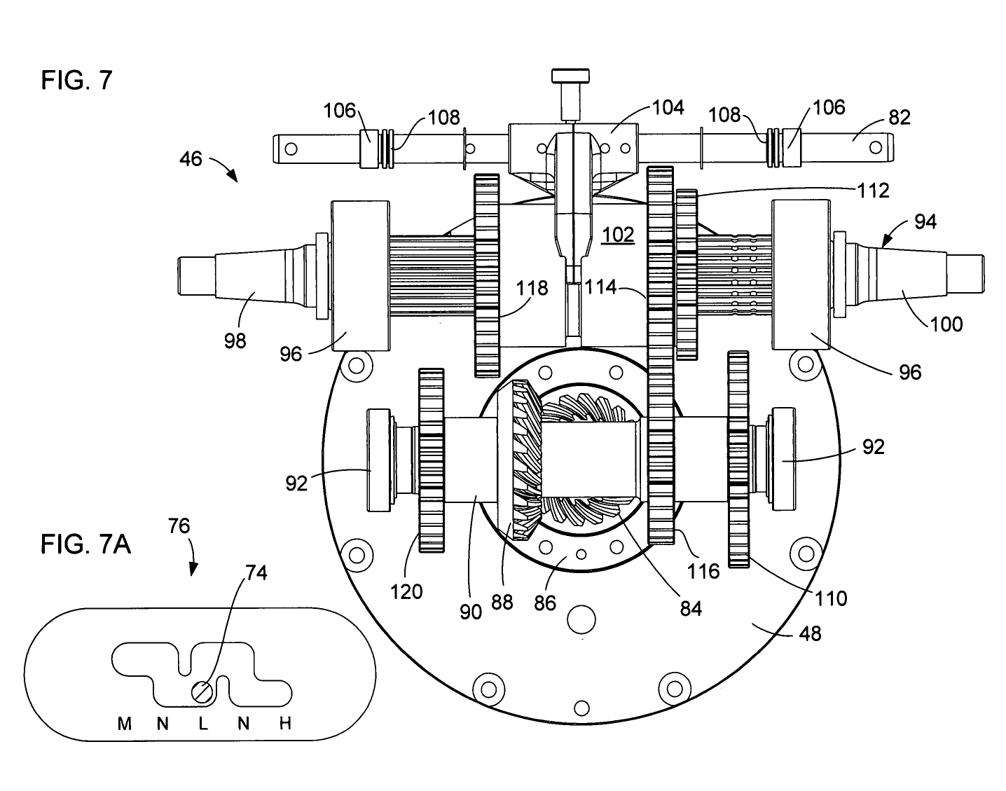

As shown in FIG. 7, the low speed output gear 116 engages the low speed output gear 118, and the other speed gears are disengaged. The low speed output gear 114 is rotationally fixed on but axially movable over the splined drive shaft 94 with the collar 102. When the gear selector shaft 82 is in the position shown in FIG. 7, according to the handle location represented in FIG. 7A, the low speed drive gear 116 engages and drives the low speed driven or output gear 114. In the low speed position, running the engine with the low speed gears engaged turns the blade drive shaft at the lowest rpm for the given configuration.

As shown in FIG. 8, the drive shaft 90 includes a second neutral position where none of the drive gears on the drive shaft 90 engage any of the output gears on the splined shaft 94. When the gear selector shaft 82 is in the position shown in FIG. 8, according to the handle location represented in FIG. 8A, none of the drive gears engage any of the output gears. The axial positions of the drive gears relative to each other and the axial positions of the output gears relative to each other are such as to provide complete disengagement between the drive and driven gears in the configuration shown in FIG. 8. In the configuration shown in FIG. 6, the gear arrangement has the high-speed output gear 112 aligned with but disengaged from the low speed drive gear 116, due to their respective diameters. The low speed output gear 114 is disengaged from the low speed drive gear 116 and is moved to be aligned with the space between the bevel follower gear 88 and below speed drive gear 116. Additionally, the medium speed output gear 118 is aligned with the space between the bevel follower gear 88 and the medium speed drive gear 120. Therefore, none of the speed gears are engaged.

As shown in FIG. 9, the medium speed output gear 118 is shifted into engagement with the medium speed drive gear 120, and the other speed gears are disengaged. The medium speed output gear 118 is rotationally fixed on but axially movable over the splined drive shaft 94 with the collar 102. When the gear selector shaft 82 is in the position shown in FIG. 9, according to the handle location represented in FIG. 9A, the medium speed drive gear 120 engages and drives the medium speed driven or output gear 118. In the medium speed position, running the engine with the medium speed gears engaged turns the blade drive shaft at an rpm intermediate the lowest and highest rpm for the given configuration.

While other gear configurations and combinations are possible, the configurations and combinations shown in the drawings provide to neutral positions, permitting easier shifting into and out of engagement, as well as allowing the operator to move the saw without the blade turning. The gearbox also conveniently has only two shafts also permitting a relatively small gearbox. The configurations also permit a relatively small sized gearbox. Additional blade speed ratios can be achieved by changing output or blade drive shaft pulleys.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. A concrete saw comprising:
a motor;
a blade support element for supporting and driving a cutting blade;
at least one gear in a drive path between the motor and the blade support element configured to drive the blade support element for driving the blade and wherein the gear is arranged in such as way as to include a neutral position where the blade support element is not driven; and
a flexible drive element in the drive path between the at least one gear and the blade support element.

2. The saw of claim 1 wherein the at least one gear includes a plurality of gears and wherein the plurality of gears are configured to operate at three speeds.

3. The saw of claim 1 wherein the flexible drive element includes a belt.

4. The saw of claim 1 wherein the motor includes an output shaft, wherein the saw is configured to move in a first direction and wherein the output shaft is parallel to the first direction.

5. The saw of claim 1 wherein the at least one gear is arranged in a gearbox having a drive input and wherein the drive input is at an approximate center widthwise of the gearbox.

6. The saw of claim 1 wherein the at least one gear includes a plurality of gears and wherein the gears are configured to have two neutral positions.

7. The saw of claim 1 wherein the at least one gear includes a plurality of gears and wherein the gears have a linear transition between a first speed and a second speed and between the second speed and a third speed and wherein the transitions are not in speed sequence.

8. The saw of claim 1 wherein the at least one gear includes a plurality of gears and wherein the plurality of gears are arranged on two shafts between the motor and the blade support element.

9. The saw of claim 1 wherein the at least one gear includes a plurality of gears, wherein the motor includes a motor output shaft, wherein the plurality of gears are arranged on at least one shaft, and wherein the motor output shaft has a gear engaging a gear on the at least one shaft.

10. A concrete saw comprising:
a motor;
a support for supporting and driving a cutting blade;
a gearbox configured for driving the blade support at at least two different speeds wherein the gearbox has no more than three shafts supporting gears; and
a flexible drive element between the blade support and the gearbox.

11. The saw of claim 10 wherein the gears are configured to drive the blade support at three different speeds.

12. The saw of claim 10 wherein the flexible drive element is at least one belt between the gearbox and the blade support.

13. The saw of claim 10 wherein the motor has an output shaft parallel to a direction of motion of the saw.

14. The saw of claim 10 wherein the gearbox is configured to have at least one neutral position.

15. The saw of claim 14 wherein the gearbox is configured to have two neutral positions.

16. The saw of claim 10 wherein the gearbox is configured to have three speed configurations with a shaft movable from one speed configuration to a second speed configuration and from the second speed configuration to a third speed configuration and wherein the shift sequence is not in numerical order.

17. The saw of claim 16 wherein the shift sequence includes from high, to low to medium.

18. A concrete saw comprising:
a motor having an output shaft wherein the output shaft is oriented parallel to a direction of travel of the saw;
a support for a saw blade for supporting and driving a saw blade;
a gearbox rigidly coupled to the output shaft wherein the gearbox is configured to drive the blade at at least two different speeds; and
a flexible driving element between the gearbox and the blade support for driving the blade support.

19. The saw of claim 18 wherein the gearbox is configured to operate at three speeds.

20. The saw of claim 18 wherein the gearbox is configured to have at least one neutral position.

21. The saw of claim 20 wherein the gearbox is configured to have two neutral positions.

22. The saw of claim 18 wherein the gearbox is configured to have a plurality of gears arranged on two shafts.

23. A concrete saw for moving along a surface to be cut, the saw comprising:
a saw frame supported for moving along the surface;
a motor supported by the saw frame for moving along the surface and having an output element;
a blade support element supported by the saw frame and for supporting and driving a cutting blade; and
a gearbox supported for movement with the saw frame along the surface and wherein the gearbox has at least one driving gear and at least one driven gear configured to be engageable with and disengageable from the at least one driving gear and wherein the gearbox is configured to include a neutral position in which the blade support element is not driven by the motor.

24. The concrete saw of claim 23 wherein the gearbox includes first and second gear shafts arranged parallel to each other, with one of the first and second gear shafts positioned vertically above the other of the first and second gear shafts.

25. The concrete saw of claim 24 wherein the first gear shaft is an input shaft having a plurality of gears on the input shaft.

26. The concrete saw of claim 25 wherein the second shaft includes a plurality of gears.

27. The concrete saw of claim 26 wherein the second shaft includes an element for receiving a gear selector fork.

28. The concrete saw of claim 27 wherein the second shaft includes a splined portion.

29. The concrete saw of claim 28 wherein the second shaft includes gears configured to engage the splined portion of the second shaft.

30. The concrete saw of claim 29 wherein the second shaft includes at least three gears.

31. The concrete saw of claim 24 wherein the first and second shafts include respective gears and wherein the second shaft includes splines and wherein at least one of the gears on the second shaft is movable over the splines of the second shaft by means of a gear selector.

32. The concrete saw of claim 31 wherein the gear selector includes a gear selector fork.

33. The concrete saw of claim 24 wherein the first gear shaft is an input shaft and the input shaft includes at least three gears.

34. The concrete saw of claim 24 wherein the first gear shaft is an input shaft having a plurality of gears on the input shaft and the second gear shaft is above the first gear shaft.

35. A concrete saw for moving along a surface to be cut, the saw comprising:
a saw frame supported for moving along the surface;
a motor supported by the saw frame for moving along the surface and having an output element;
a blade drive shaft supported by the saw frame for a cutting blade;
a gearbox supported for movement with the saw frame along the surface and wherein the gearbox has at least one driving gear and at least one driven gear higher than the at least one driving gear and configured to be engageable with and disengageable from the at least one driving gear and wherein the gearbox is configured to include a neutral position wherein the at least one driving gear and the at least one driven gear are disengaged and in which the blade support element is not driven by the motor; and
a flexible driving element in a drive path between the gearbox and the blade drive shaft.
